(19) United States
(12) Patent Application Publication
(10) Pub. No.: US 2024/0375259 A1
(43) Pub. Date: Nov. 14, 2024

(54) HANDHELD DEVICE WITH COMPONENTS THAT CAN COMMUNICATE ON AN EQUAL FOOTING VIA A UNIVERSAL BUS CONNECTION

(71) Applicant: WÜRTH INTERNATIONAL AG, Chur (CH)

(72) Inventors: Heiko ROSSKAMP, Adelberg (DE); Adrien MARQUETTE, Schwäbisch Hall (DE); Louisa ASCHOFF, Neuenstein (DE); Fangzhou YU, Künzelsau (DE)

(21) Appl. No.: 18/688,277

(22) PCT Filed: Jul. 28, 2022
(86) PCT No.: PCT/EP2022/071168

§ 371 Date: Feb. 29, 2024

(30) Foreign Application Priority Data
Aug. 31, 2021 (EP) 21290053.4
Aug. 31, 2021 (EP) 21290054.2
Aug. 31, 2021 (EP) 21290055.9
Sep. 24, 2021 (EP) 21290059.1

(51) Int. Cl. B25F 5/00; B25B 23/147; G06F 13/42

(52) U.S. Cl. CPC B25F 5/00; B25B 23/1475; G06F 13/4282; G06F 2213/0042

(57) ABSTRACT

Handheld device for manual actuation by a user, the handheld device comprising a machining and driving device which is configured to process a substrate by means of a driving force, and at least one further component which can be electromechanically coupled or is coupled to the machining and driving device, the machining and driving device and the at least one further component being configured to communicate with one another on an equal footing by means of a universal bus connection.

### CROSS-REFERENCE TO RELATED APPLICATION

This application is a national stage application, filed under 35 U.S.C. § 371, of International Patent Application No. PCT/EP2022/071168, filed on Jul. 28, 2022, claiming priorities of the European patent applications EP 21 290 053.4 filed on Aug. 31, 2021; EP 21 290 054.2 filed on Aug. 31, 2021; EP 21 290 055.9 filed on Aug. 31, 2021; and EP 21 290 059.1 filed on Sep. 24, 2021, all of them being incorporated by reference herein in its entirety.

### FIELD OF INVENTION

The invention relates to a handheld device, an arrangement and a method for controlling a handheld device configured for a manual operation by a user.

### ART BACKGROUND

Conventional handheld devices are controlled directly by a user. For example, a drill is controlled by a user inserting a suitable drill bit into the drill and then pressing an actuation button on the drill. If a user without specialist knowledge performs a delicate manual task using such a handheld device, this can lead to incorrect operation, an undesirable result and a risk to operational safety.

DE 10 258 900 A1 discloses a cordless screwdriver for tightening screw components, with a screwdriver motor which is supplied with electrical voltage from a self-sufficient power supply arranged on the cordless screwdriver, at least three measuring devices which are provided for monitoring screwdriving parameters during the screwdriving process, namely a torque sensor, with which the tightening torque generated by the screwdriver motor can be measured, a rotation angle sensor, with which the current screw-in angle can be measured starting from a predetermined measuring position, and a current sensor, with which the drive current of the screwdriver motor can be measured. Furthermore, monitoring electronics are provided which switch off the screwdriver motor if the tightening torque, the screw-in angle and the drive current are all within a predetermined, assigned target parameter window.

Conventional handheld devices reach their limits, especially when it comes to difficult or unusual processing tasks using a handheld device.

### SUMMARY OF THE INVENTION

It is a need of the present invention to enable operation of a handheld device in a simple, safe, flexible and error-resistant manner.

This need is met by the objects with the features according to the independent patent claims. Further embodiments are shown in the dependent claims.

According to one embodiment of the present invention, a handheld device is created for manual operation by a user, the handheld device comprising a machining and driving device which is configured to machine a substrate by means of a drive force (in particular a drive torque and/or a longitudinal force), and at least one further component (in particular a token and/or a detection and/or control adapter) which can be electromechanically coupled or is coupled to the machining and driving device, wherein the machining and driving device and the at least one further component are configured to communicate with each other on an equal footing by means of a (in particular wired) universal bus connection.

According to a further embodiment of the present invention, an arrangement is provided which has a handheld device with the features described above and at least one communication partner device which is configured to communicate with at least one component other than the machining and driving device and the at least one further component by means of a (in particular wireless) communication link which is different from the (in particular wired) universal bus connection.

According to a further embodiment of the invention, a method is provided for controlling a handheld device configured for manual operation by a user, in particular with the features described above, wherein the method comprises machining a substrate using a driving force by means of a machining and driving device of the handheld device, providing drive energy for driving the machining and driving device (for example by means of a power supply device of the handheld device or by connecting the handheld device to a power supply system), electromechanically coupling at least one further component of the handheld device to the machining and driving device (and/or optionally the optional power supply device), and communicating on an equal footing between the machining and driving device and the optional power supply device, electromechanically coupling of at least one further component of the handheld device with the machining and driving device (and/or optionally the optional power supply device), and a communication on an equal footing between the machining and driving device and the at least one further component (and/or, if present, the optional power supply device) with one another by means of a universal bus connection.

In the context of the present application, a “handheld device” can be understood in particular as a portable device which can be manually operated and carried by a user and with which it is possible to machine a substrate. In particular, a hole can be drilled in the substrate and/or a driving force in the form of a longitudinal force and/or a torque can be applied to a fastening element to be set in a substrate by means of a handheld device and by applying a driving force in the form of a longitudinal force and/or a torque. In particular, the driving force can be a rotational or rotary driving force, optionally superimposed with a translational driving force. In other words, the handheld device can be configured to rotationally drive a machining and driving device and thus a drill and/or a fastening element. Alternatively, the drive force can also be a purely translational drive force. A drive force of a handheld device can be a pneumatic, hydraulic or electric drive force, which is generated, for example, by a pneumatic device, a hydraulic device or an electric motor. Examples of handheld devices are a cordless screwdriver, a cordless drill, a rotary screwdriver, a pulse screwdriver, a ratchet screwdriver, a drill, an impact screwdriver (especially a cordless impact screwdriver), a hammer drill and an eccentric grinder. However, a handheld device can also be a hair dryer, a vacuum cleaner or a mortar press.

In the context of this application, the term “machining and driving device” can be understood in particular to mean a mechanism or an assembly which enables machining, in particular machining which places a fastening element or machining which removes material or drills holes in the substrate. In particular, the machining and driving device can have a bit housed in a chuck for actuating a drive in a head of a fastening element for inserting (with or without pre-drilling) the fastening element into the substrate by means of the handheld device. It is also possible that the machining and driving device comprises a bit housed in a chuck for drilling a hole in a substrate. Furthermore, the machining and driving device can have a drive unit, such as a motor (in particular an electric, hydraulic or pneumatic motor), which provides drive energy (in particular a torque) during operation to carry out the machining task. The machining and driving device can be accommodated in and/or on a common base body or main housing of the handheld device.

In the context of the present application, the term “substrate” can be understood to mean in particular a wall, further in particular a vertical wall, a ceiling, a floor or a device (for example a piece of furniture). Materials for such an anchoring base are in particular wood or wood building materials, or also concrete and masonry building materials, metal or plastic components. Furthermore, such a substrate can also be any composite material consisting of several different material components. The substrate can have cavities or can be solid (i.e. free of cavities).

In the context of this application, the term “additional component” can be understood in particular to mean an additional hardware block or function block which can interact functionally in a modular manner at least with the machining and driving device and/or the power supply device in order to jointly provide a handheld device function. For example, such an additional component can be a token, a detection and/or control adapter, an additional power supply device, an additional machining and driving device, etc.

In the context of this application, the term “electromechanically coupling” can be understood to mean in particular the formation of a mechanical connection between the individual components or modules (in particular machining and driving device, power supply device, token, detection and/or control adapter, additional power supply device, additional machining and driving device, etc.) of the handheld device, which simultaneously leads to the formation of an electrical coupling between the said components or modules of the handheld device. In this case, a positive coupling of the components or modules, for example, can also enable the transmission of an electrical control signal and/or the transmission of electrical drive energy from an electrical contact of one component to an electrical contact of the other component mechanically coupled to it.

In the context of this application, the term “communication on an equal footing by means of a universal bus connection” can be understood in particular to mean a communication architecture between the components or modules of the handheld device, in which the communicating components or modules are at the same prioritization level with regard to the transmission of control signals or other data and/or energy transmission. In the case of such communication on an equal footing, there is no mutual superordination-subordination relationship between the components or modules, but rather equal priority with regard to the processing and transmission of control signals or other data and/or energy transmission. According to embodiments of the invention, a universal bus connection can be used for communication on an equal footing between the components or modules, i.e. the same communication system can be used for all components or modules. A bus can be described as a system for data transmission between several components via a common transmission path. If a momentary data transmission takes place between two components, the other components can refrain from transmitting data at the same time in order to avoid a collision. According to embodiments, the bus connection can be serial or parallel. With a serial bus connection, data and/or energy transmission processes can be carried out one after the other via a transmission line. In the case of a parallel bus connection, a plurality of transmission lines running next to each other can be provided, via which data and/or energy transmission processes can also be carried out simultaneously.

In the context of this application, the term “communication partner device” can be understood in particular to mean a device with communication resources that can be communicatively coupled with one or more components or modules of the handheld device. This communication can preferably be wireless, but can alternatively also be wired. For example, a communication partner device can communicate exclusively with one or more tokens of a handheld device, but not with other components (e.g. a processing and control device, a power supply device, etc.).

According to an exemplary embodiment of the invention, a handheld device is provided which is constructed from several components or modules which have at least one machining and driving device for machining a substrate and at least one further component (for example a detection and/or control adapter, a token, etc.). Such a handheld device can be flexibly assembled from the individual components in a modular manner according to the needs of a user or application, in particular by forming an electromechanical coupling. Since a universal bus connection is implemented between said components with equal priority of the components with regard to their data transmission rights, particularly fast data transmission (e.g. of control signals for operating the handheld device) between the components is possible.

In an arrangement comprising such a handheld device and a communication partner device communicably coupled to at least some of the components of the handheld device, communication with the communication partner device can be handled via a different (preferably wireless) communication link than the universal bus connection on an equal footing. In this way, it is possible to have at least one component of the handheld device communicate with a communication partner device outside the handheld device, for example to allow control of the handheld device by a user from a remote position and/or to be able to transmit information (for example a data sheet or data relating to the processing of a machining task by the handheld device) via the additional communication link. The use of a separate communication link for this purpose increases the flexibility and application possibilities of the arrangement. A basic idea of embodiments of the invention can be seen in the fact that different machine components of a handheld device can each talk to each other via an equally authorized bus. This significantly simplifies the communication architecture. Advantageously, such a universal bus system can be used to communicate with all communicable components of a handheld device.

Additional exemplary embodiments of the handheld device, the arrangement and the method are described below.

According to an exemplary embodiment, the handheld device can have a power supply device (for example at least one battery pack) (in particular electromechanically coupled or couplable to the machining and driving device), which is configured to provide (in particular electrical) drive energy for driving the machining and driving device, wherein the at least one further component can be electromechanically coupled or is coupled to the power supply device, and wherein the machining and driving device, the power supply device and the at least one further component are configured to communicate with each other on an equal footing by means of the universal bus connection. In the context of this application, the term “power supply device” can be understood in particular to mean a hardware component for providing energy, in particular electrical energy, for operating at least one component of the handheld device, in particular for operating the machining and driving device. For example, the power supply device can be a battery pack or a rechargeable battery pack. Advantageously, each of the machining and driving device, the power supply device and the at least one further component can be communicably coupled to at least one other of the machining and driving device, the power supply device and the at least one further component by means of the universal bus connection.

However, it should be noted that the handheld device can also be configured without a modular power supply unit (such as a battery pack). For example, the power supply of the handheld device can be supplied with energy by a connection cable with a connector plug for plugging into a socket for coupling to a power supply system. For example, a hand-held appliance, such as a hair dryer, can be supplied with electrical drive energy in this way. Thus, according to exemplary embodiments of the invention, hand-held appliances can be operated either wired (i.e., for example, using a power cable and a socket) or wirelessly (for example, using a battery pack or other power supply device).

According to an exemplary embodiment, the universal bus connection can be a Universal Asynchronous Receiver Transmitter (UART) bus connection. A UART bus connection can be realized by means of an electronic UART circuit (for example in the form of at least one processor or a part thereof), which can be contained, for example, in a respective one of the communicable components (in particular machining and driving device, power supply device, further component(s)) of the handheld device and which can provide a (in particular serial) interface for data transmission. For example, with a UART bus connection, data can be transmitted between different components as a serial digital data stream with a fixed frame, which can have at least one start bit, several (in particular five to nine) data bits, an optional check bit for detecting any transmission errors and at least one stop bit. A receiver component can determine a clock of a transmitter component from a clock of the data line and synchronize itself accordingly using the start and stop bits. A UART bus connection has proven to be a particularly error-resistant and fast communication interface for the requirements of flexibly combinable modular components of a handheld device.

Alternatively, the universal bus connection on an equal footing between the components of the handheld device can also be implemented in another way, for example using a field bus such as a CAN (Controller Area Network) bus, which can use several controlling components with equal rights according to a multi-master principle.

According to an exemplary embodiment, the universal bus connection can provide peer-to-peer communication between the machining and driving device, the power supply device and the at least one further component. Peer-to-peer communication within the handheld device can be understood here in particular as communication between equals, in which all components (machining and driving device, power supply device, at least one other component) have equal rights with regard to their authorization profiles for communicating with each other and can both use services and provide services. Within the handheld device, however, the individual components can be divided into different groups depending on their qualification, to which specific properties are assigned.

According to an exemplary embodiment, the machining and driving device, the power supply device and the at least one further component can be configured to communicate with each other on an equal footing by means of the universal bus connection with the proviso that communication between the machining and driving device and the power supply device is prioritized when an exceptional situation is detected (in particular in the event of a collision and/or bandwidth shortage). While the principle of communication on an equal footing between the components of the handheld device is also maintained in the described embodiment, in a specific exceptional case it may be advantageous to prioritize communication between the machining and driving device and the power supply device over other communication paths within the handheld device (for example between a token and the power supply device or between a detection unit and a control unit). This can mean that a desired data and/or energy transmission between the machining and driving device and the power supply unit is given priority (especially first), even though, for example, another data and/or energy transmission between other components of the handheld device is to be carried out simultaneously or overlapping. A scenario in which such prioritization is exceptionally carried out may exist in the event of a bandwidth shortage of the bus connection, in which the transmission capacity of the universal bus connection is not sufficient to carry out several data and/or energy transmissions simultaneously. In this case, the data and/or energy transmission between the machining and driving device and the power supply device can be carried out first and the competing data and/or energy transmission can be carried out afterwards. Another scenario in which such prioritization is exceptionally carried out is when a data and/or energy transmission is disrupted by another data and/or energy transmission. If there is a risk of such interference during simultaneous data and/or energy transmission between the machining and driving device and the supply device on the one hand and another pair of components of the handheld device on the other hand, or if such interference is detected (for example by sensors), the data and/or energy transmission is first carried out between the machining and driving device and the power supply device. The described prioritization of communication between the machining and driving device and the power supply device advantageously maintains a basic function of the handheld device (for example, motorized drilling with a drill) and, in contrast, returns additional functions of the handheld device (for example, targeted control of drilling to achieve a target configuration using a detection unit and a control unit) in exceptional cases.

According to an exemplary embodiment, the machining and driving device, the power supply device and the at least one further component can be configured to communicate with each other simultaneously or sequentially by means of the universal bus connection. In the case of simultaneous communication, several data and/or energy transmission processes can be carried out simultaneously via the universal bus connection, for example in the case of a parallel bus connection. This allows a particularly high transmission capacity. In the case of sequential communication, the data and/or energy transmission processes are carried out one after the other, which can reduce the risk of collisions or faulty data and/or energy transmission processes.

According to an exemplary embodiment, the at least one further component can have a detection unit which is configured to detect detection data indicative of a force transmission during machining the substrate by means of the machining and driving device. Alternatively and preferably in addition, the at least one further component can have a control unit which is set up to control the machining of the substrate in accordance with a target specification. In particular, the control unit can perform said control based on detection data detected by the detection unit. For this purpose, the control unit can be communicatively coupled with the detection unit. According to such an embodiment, a handheld device is provided for machining a substrate, which detects a force transmission characteristic (for example a transmitted torque) by sensors and, if necessary, adapts the machining of the substrate on the basis of the detected force transmission characteristic in order to carry out the substrate machining in accordance with a target specification and to compensate for any deviations from the target specification in whole or in part. In this way, using detection resources and control resources, it can be ensured that even a less experienced user or a user performing a delicate subsurface machining task can perform the subsurface machining task in an error-resistant, precise and user-friendly manner. Such a handheld device can therefore measure a force-related parameter (e.g. a torque) in the area of its tip by means of the detection unit, preferably directly at the point of force transmission. The result of this measurement can then be used to determine any deviations from a desired target specification and to adapt the control of the handheld device so that any discrepancies between the actual process characterized by the sensor and a target process defined by the target specification can be fully or partially compensated or corrected when performing a surface treatment task. It is particularly advantageous here to configure the components used for the detection-based control of the execution of a subsurface treatment task to fulfill a target specification, namely a detection unit and a control unit, as a module or modules that can be easily retrofitted in a conventional handheld device without such functionality. Such a handheld device can be used with or without the retrofit kit to machine a substrate. This also makes it possible to retrofit existing handheld devices with a combined detection and control architecture or to provide corresponding detection and control modules together for several handheld devices and to attach them to a specific handheld device as required in order to extend its functionality. Such a modular architecture makes it possible to adapt a standard handheld device in such a way that actual force transmission parameters can be detected and the handheld device can be controlled in accordance with the detected force transmission parameters to achieve a target specification.

According to an exemplary embodiment, the detection unit can be attached or mounted to the machining and driving device, in particular configured as a removable detection adapter. The detection unit can thus be configured as a separate module that can be attached to the handheld device, and in particular to its machining and driving device, or not. This configuration makes it easier to retrofit a conventional handheld device with a detection unit. Attaching the detection unit to the machining and driving device is particularly advantageous, as the detection of at least one parameter indicative of the force transmission can be carried out by the handheld device.

According to an exemplary embodiment, the control unit can be attached or mounted to the power supply device, in particular as a detachable control adapter. The control unit can thus be configured as a separate module that can be attached to the handheld device, and in particular to its power supply device, or not. This configuration makes it easier to retrofit a conventional handheld device with a control unit. Attaching the control unit to the power supply device is particularly advantageous, as the control of the energy supply has a sensitive influence on the machining of the substrate. In particular, the control unit can set the degree of energy supply by the power supply device to the machining and driving device.

According to an exemplary embodiment, the detection unit and the control unit can form an adapter that is physically connected to each other and can be handled separately from the rest of the handheld device, in particular comprising a connecting body mechanically connecting the detection unit and the control unit outside the rest of the handheld device. For example, the connecting body can be a rigid strut that can be held manually by a user to mount the common detection-control module on the handheld device. When mounted on the handheld device, the strut can be arranged at an angle when the machining and driving device is attached to the substrate for horizontal processing of a vertical substrate.

According to an exemplary embodiment, the at least one further component can have at least one token configured in such a way that the token controls at least one part of the handheld device when mechanically coupled with at least one of the machining and driving device, the power supply device and another of the at least one further component. Alternatively or additionally, the token can transmit data, in particular parameter values, between components (for example from a module to the handheld device). For example, the handheld device can access this data during a subsequent or next operation. In the context of the present application, a “token” can be understood in particular as a recognition marker that can form a functional coupling between the token and a component (for example, machining and driving device, power supply device, detection unit or control unit) of the handheld device. Such a recognition token can be used in particular in a coupled arrangement, which can comprise the token, a component of the handheld device mechanically coupled to it and optionally one or more communication partner devices. In particular, a token may be a hardware component for identifying and/or authenticating a user to whom the token may be assigned. A token may be an electronic token and may, for example, provide a processor-related control, monitoring and/or communication function. According to the described embodiment, a universally applicable token can be provided for selectively controlling a respective one of a plurality of components of the handheld device, wherein by mechanically coupling the token to a particular component, communication is formed between the token and said component via the universal bus connection, enabling control. Thus, a user can assign the token to the component to be controlled by simply carrying out the intuitive process of mechanically coupling the token to a selected component of the handheld device (for example by inserting the token into a receiving opening of the component); no further user activity is required to assign and controllably couple the token and component. Preferably encrypted and therefore secure communication between the token and the mechanically coupled component of the handheld device enables reliable control once the mechanical coupling has been formed. Operational reliability can also be increased by establishing a specific mechanical connection between the token and the component in order to form a control coupling between the token and the component. An owner of a (preferably user-related) token can thus define exactly which component of the handheld device is to be controlled with the token. By means of a token according to an exemplary embodiment of the invention, it is also possible to retrofit a handheld device or a component thereof to provide Internet connectivity.

According to an exemplary embodiment, the token can be configured as a plug-in element for insertion into a receiving opening, in particular configured as an electromechanical interface, of at least one of the machining and driving device, the power supply device and the at least one of the at least one further component. The process of inserting the token, which is configured as a plug-in element, into the receiving opening of a component of the handheld device selected in this way only then intuitively triggers the formation of a controllable connection between the token and the component. For example, a geometry of the token configured as a plug-in element can be inverse to a geometry of the receiving opening in the component. A connection between token and component can then be formed according to a lock-and-key principle in order to establish a communicable coupling by means of the universal bus connection. By inserting a token into a receiving opening of a component of the handheld device, the token can be protected from environmental influences during operation of the handheld device.

According to an exemplary embodiment, the token can have a processor, which is configured for control-related interaction with the machining and driving device, the power supply device and optionally the other of the at least one further component, and a mechanical coupling device, which is configured for mechanical coupling with the machining and driving device, the power supply device and the optional other of the at least one further component, wherein the token is configured to control the respective one of the machining and driving device, the power supply device and the optional other one of the at least one further component by means of the processor when the mechanical coupling device is mechanically coupled to a respective one of the machining and driving device, the power supply device and the optional other one of the at least one further component. The token can, on the one hand, be configured to communicate via the universal bus connection with another component (in particular with the machining and driving device, the power supply device, a detection unit and/or a control unit) of the handheld device and, on the other hand, be configured to communicate via a separate other communication link (which can preferably be wireless) with one or more other communication partner devices. In this way, by inserting a token into a component of the handheld device, this component can be coupled to an additional communication network (for example the public Internet) by means of the token. This makes it possible to make a handheld device or a component thereof Internet-enabled. As a result, the token can be used to download documents (e.g. operating instructions) from the additional communication network to a component of the handheld device. Alternatively or additionally, documents can be uploaded from the component via the additional communication network to a communication partner device, for example data documenting the execution of a processing task by the handheld device, by means of the described communicable coupling of a component of the handheld device with the token.

According to an exemplary embodiment, the machining and driving device can be configured to communicate bidirectionally with the power supply device by means of the universal bus connection, the power supply device can be configured to communicate bidirectionally with a further component configured as a token by means of the universal bus connection, and the token can be configured to communicate with a communication partner device according to a wireless communication link different from the universal bus connection. One such embodiment is shown in FIG. 2.

According to another exemplary embodiment, the machining and driving device can be configured for bidirectional communication with a further component configured as a detection and/or control adapter by means of the universal bus connection, the detection and/or control adapter can be configured for bidirectional communication with the power supply device by means of the universal bus connection, each of the machining and driving device, the detection and/or control adapter and the power supply device can be configured to communicate bidirectionally with a respective token of the at least one further component by means of the universal bus connection, and each of the tokens can be configured to communicate with a communication partner device in accordance with a wireless communication link different from the universal bus connection. FIG. 3 shows a corresponding embodiment.

According to yet another exemplary embodiment, the machining and driving device can be configured for bidirectional communication with a further component configured as a detection and/or control adapter by means of the universal bus connection, the machining and driving device can be configured for bidirectional communication with the power supply device by means of the universal bus connection, the machining and driving device can be configured for bidirectional communication with a further component configured as a further power supply device by means of the universal bus connection, the detection and/or control adapter can be configured to communicate bidirectionally with the power supply device and with the further power supply device by means of the universal bus connection, each of the machining and driving device, the detection and/or control adapter, the power supply device and the further power supply device can be configured to communicate bidirectionally with the power supply device and with the further power supply device by means of the universal bus connection, the power supply device and the further power supply device can be configured for bidirectional communication with a respective further component configured as a token by means of the universal bus connection, and each of the tokens can be configured for communication with a communication partner device in accordance with a wireless communication link different from the universal bus connection. Such a configuration is shown in FIG. 4.

According to an exemplary embodiment, the at least one communication partner device can be selected from a group consisting of a computer (for example a central control computer for controlling several handheld devices or a reordering device for automatically reordering consumables (e.g. screws) used by the handheld device) and a portable user terminal (in particular a tablet or a mobile device). Such a computer can, for example, be a central control computer of an organization that controls many decentralized handheld devices or, more generally, many devices of a craftsman's equipment. It is also possible for such a computer to be a reordering device that reorders consumables (e.g. screws or dowels) required in connection with the handheld device when the communication network notifies the user that a remaining stock of consumables has fallen below a predetermined level. A communication partner device configured in particular as a portable user terminal also allows the handheld device to be controlled by a user from a remote position, for example via a smartphone.

According to an exemplary embodiment, the at least one communication partner device and the handheld device can be communicatively coupled by means of the Internet, an intranet or a mobile network. A corresponding communication device of the communication partner device and a communicable component (for example a token) of the handheld device can, for example, include a transmitting and/or receiving antenna and an associated processor resource, which enable, for example, wireless communication in such a communication network. In this way, a token of the handheld device can communicate unidirectionally or bidirectionally with one or more other communication partner devices beyond the control of a component of the handheld device mechanically coupled to it, for example to download (download) and/or upload (upload) information. For example, a download of information from a communicatively coupled communication partner device to the token may include a download of a user profile or a sequence control of a processing task to be performed by a user by means of a handheld device in which the token is coupled. For example, an upload of information from the token to a communicatively coupled communication partner device can include an upload of tracking data that enables tracking of an operation of the token and/or an associated handheld device for documentation and/or quality monitoring purposes. Operating data documenting the execution of a processing task by a handheld device assigned to the token can also be uploaded from the token to a communicatively coupled communication partner device.

According to an exemplary embodiment, the communication link different from the universal bus connection can be a wireless communication link. This enables wireless operation of the handheld device while simultaneously enabling coupling with a communication network. Alternatively, the communication link different from the universal bus connection can be wired.

According to an exemplary embodiment, the communication link can be a GPS (Global Positioning System) communication link, a BLE (Bluetooth Low Energy) communication link, an ultra-wideband (UWB) communication link, a Bluetooth communication link, a WLAN (Wireless Local Area Network) communication link, a narrowband Internet of Things (IoT) communication link, a 5G communication link, an LTE (Long Term Evolution) communication link, a WLAN (Wireless Local Area Network) communication link, a narrowband Internet of Things (IoT) communication link, a 5G communication link, an LTE (Long Term Evolution) communication link, a COTM (Communications On The Move) communication link, a SigFox communication link and/or a LoRa communication link. A Bluetooth and an IoT communication link are preferred. By means of such a communication link, wireless communication of the token via a communication network is possible, which enables further refined control of a handheld device mechanically coupled to the token using data transmitted via the communication network.

According to an exemplary embodiment, the handheld device can be provided with the machining and driving device and a token can be attached to the handheld device as at least one further component (in particular, it can be inserted into an insertion opening). The token can, for example, be equipped with its own battery and can download a data set from a communication partner device via the communication network coupled to the handheld device using the operating energy stored there (for example, download a data sheet with operating parameters for setting a screw from the Internet). This data set can then be stored locally on the handheld device, for example on a storage device of the token or another component. For example, the handheld device can then be coupled to a power supply device (e.g. a battery pack). In particular, the machining and driving device can perform a processing task with energy from the power supply device and using the downloaded data set.

In the following, exemplary embodiments of the present invention are described in detail with reference to the following figures.

### BRIEF DESCRIPTION OF THE DRAWINGS

FIG. 1 shows an arrangement with a multi-component handheld device and a communication partner device communicatively coupled thereto according to an exemplary embodiment of the invention.

FIG. 2 shows an arrangement with a multi-component handheld device and a communication partner device communicatively coupled thereto according to another exemplary embodiment of the invention.

FIG. 3 shows an arrangement with a multi-component handheld device and a communication partner device communicatively coupled thereto according to yet another exemplary embodiment of the invention.

FIG. 4 shows an arrangement with a multi-component handheld device and a communication partner device communicatively coupled thereto according to a further exemplary embodiment of the invention.

FIG. 5 shows a handheld device according to an exemplary embodiment of the invention.

FIG. 6 shows an arrangement with a handheld device and a token that is coupled to a communication partner device in a communication network according to an exemplary embodiment of the invention.

### DETAILED DESCRIPTION

Identical or similar components in different figures are marked with the same reference numbers.

Before exemplary embodiments of the invention are described with reference to the figures, some general aspects of embodiments of the invention will be explained:

Conventional handheld devices, such as drills, eccentric grinders, etc., can be powered by a rechargeable battery. For this purpose, a base body of the handheld device and the battery are connected to each other via an electromechanical interface. However, the battery can not only supply power to the main body, but also other information. Such further information can, for example, be information regarding the charge status of the battery, regarding the maximum available power, etc. As a result, error states of the battery and/or the base body can be detected and controlled accordingly. For example, if the battery becomes too hot, the maximum operating current can no longer be made available, but only a limited maximum current for a certain period of time, for example only 80% of the maximum power for a period of 15 minutes.

According to an exemplary embodiment of the invention, a handheld device is created in which a plurality of modular components of the handheld device are coupled to one another in a communicable manner by means of a bus connection as a universal part. The communication between the components on an equal footing within the framework of this communication (for example machining and driving device, power supply device, detection and/or control adapter, token, etc.) enables a particularly reliable guarantee of the function of the overall arrangement and fast signal and/or energy transmission. Advantageously, according to an exemplary embodiment of the invention, the direction of communication can be unrestricted and thus free. With several components of the handheld device, the control of the communication thus becomes quick and easy. For faster signal and/or energy communication between several components of a handheld device, according to embodiments of the invention, communication on an equal footing between the components is advantageous. In particular, several participants can preferably communicate via UART.

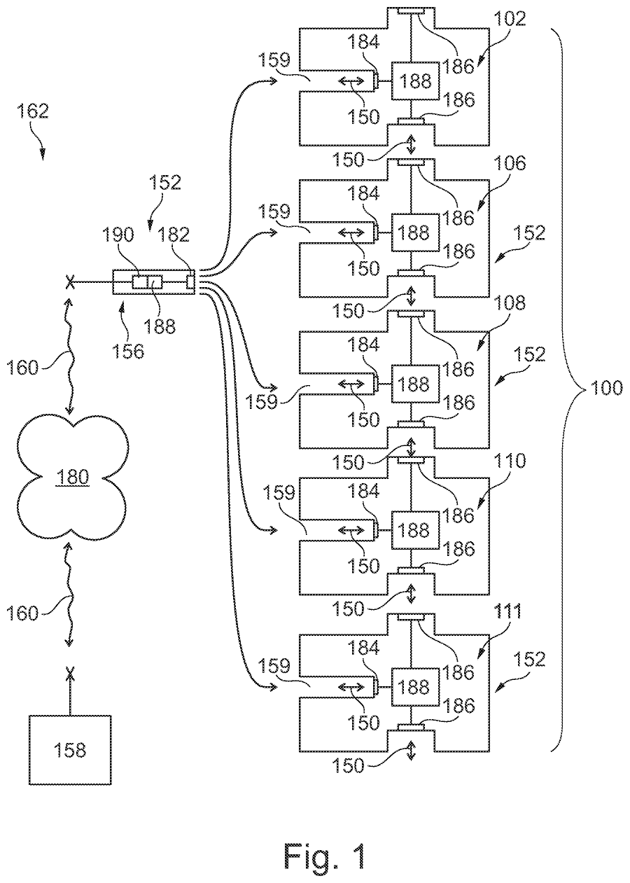

FIG. 1 shows an arrangement 162 comprising a multi-component handheld device 100 and a communication partner device 158 communicably coupled thereto, according to an exemplary embodiment of the invention.

More specifically, the arrangement 162 comprises a handheld device 100, for example formed as a drill, and a communication partner device 158 (for example a central computer or a mobile communication device) wirelessly communicably coupled thereto via a communication network 180 (for example the public Internet). In the illustrated embodiment, the communication partner device 158 can communicate with a token 156 of the handheld device 100 via a wireless communication link 160. Individual components or modules of the modular handheld device 100, on the other hand, can communicate with each other by means of a universal bus connection 150. The wired universal bus connection 150 for communication between the components of the handheld device 100 is different from the wireless communication link 160 via the communication network 180.

The handheld device 100 has as components or modules a machining and driving device 102, a power supply device 110 and further components 152. In the embodiment shown, the further components 152 are in the form of the token 156, a detection unit 106, a control unit 108 and an additional power supply device 111. The components described can be combined in a modular manner, for example by plugging them together to form an electromechanical connection, whereby, for example, a form fit and an electrical communication link for signal and/or energy transmission are formed between the components.

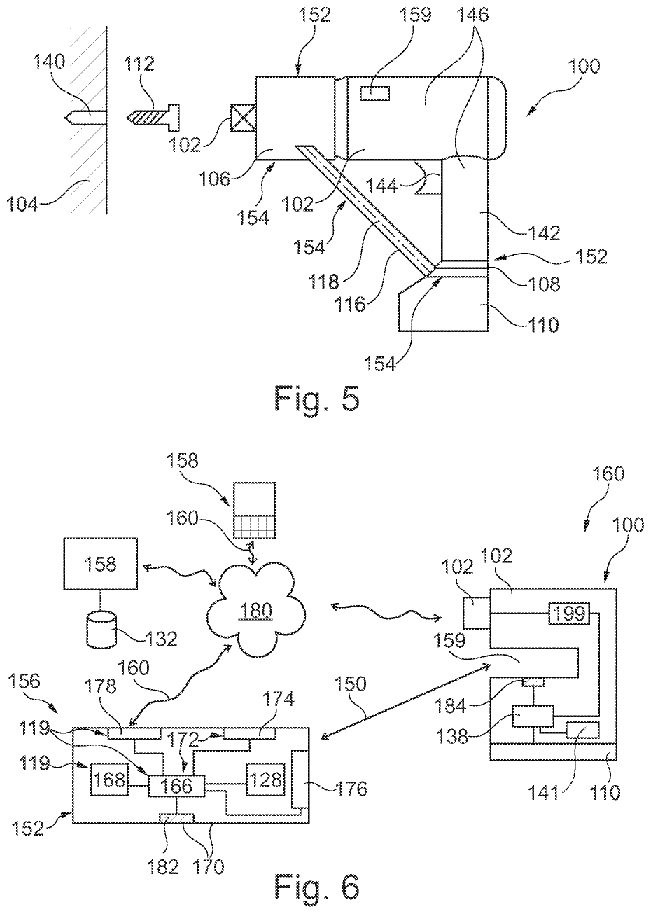

The handheld device 100 is used for manual operation by a user and has the already mentioned machining and driving device 102, which is configured for machining a substrate (for example a concrete wall, see reference sign 104 in FIG. 5) by means of a drive force and for providing the mechanical drive force (or a drive torque) used for this purpose by a drive motor. In one embodiment of the handheld device 100 as a drilling machine, the machining and driving device 102 for machining the substrate 104 can have a chuck for holding a drill bit and an electric motor drive for driving the chuck in rotation and a drill bit held therein for machining the substrate 104.

Furthermore, two separate power supply devices 110, 111 are provided in the handheld device 100 according to FIG. 1, which are configured to provide electrical drive energy for driving a drive motor of the machining and driving device 102. The two power supply devices 110, 111 are each configured as a battery pack and can be used together or individually (i.e. independently of one another) to provide electrical drive energy in the handheld device 100. Alternatively, only a single power supply device 110 may be provided.

The detection unit 106 provided as a further component 152 serves to detect detection data indicative of a force transmission during machining the substrate 104 by means of the machining and driving device 102. The modular detection unit 106 can in particular be attached to the machining and driving device 102 and thus be configured as a removable detection adapter.

An additional control unit 108, which can be communicatively coupled to the detection unit 106, can be set up based on the detection data for controlling the machining of the substrate 104 in accordance with a target specification. Preferably, the control unit 108 is attached to the power supply device 110 or to the power supply device 111 and can preferably be configured as a removable control adapter.

When respective ones of the components 102, 106, 108, 110, 111 are electromechanically coupled to each other, a respective electrically conductive contact element 186 of a respective component 102, 106, 108, 110, 111 can be electrically conductively coupled to a respective other electrically conductive contact element 186 of another component 102, 106, 108, 110, 111 coupled thereto. With such a plug-in, a contact-based communication coupling can also be effected between two respective components 102, 106, 108, 110, 111.

Further shown as a further component 152 is the token 156, wherein a plurality of tokens 156 may also be provided on a handheld device 100. The token 156 is used for mechanical coupling with a selectable one of the components 102, 106, 108, 110, 111 and can control the thereby selected and assigned component 102, 110, 111, 106 or 108 when such a coupling is formed. More precisely, the token 156 can be configured as a plug-in element for insertion into a receiving opening 159 of the respective component 102, 106, 108, 110, 111, which is configured as an electromechanical interface. By inserting the token 156 into the selected component 102, 106, 108, 110, 111, a contact-based communication coupling is also effected. For this purpose, the token 156 can have an electrically conductive contact element 182, which is coupled in an electrically conductive manner to a corresponding electrically conductive contact element 184 of the respective component 102, 106, 108, 110, 111 by insertion into a respective component 102, 106, 108, 110, 111.

Advantageously, the components 102, 106, 108, 110, 111 and 156 of the handheld device 100 may be configured to communicate with each other on an equal footing by means of a universal bus connection 150, which is preferably a Universal Asynchronous Receiver Transmitter (UART) bus connection, but another equal footing universal bus connection may also be formed. To provide this communication capability, a respective one of the components 102, 106, 108, 110, 111 and 156 may be provided with a corresponding communication unit 188 (for example, a processor with memory resources). Said universal bus connection 150 may advantageously enable peer-to-peer communication between the components 102, 106, 108, 110, 111 and 156. In principle, each data and/or energy transfer between a respective pair of the components 102, 106, 108, 110, 111 and 156 is treated as equivalent within the universal bus connection 150, so that no prioritization is performed in this respect. For example, data and/or power transfer operations between a respective pair of the components 102, 106, 108, 110, 111 and 156 can be processed according to the “first come, first served” principle, i.e. according to the order of the intended data and/or power transfer operations. This can be advantageous, for example, in the case of a serial universal bus connection 150. In the case of a parallel universal bus connection 150, data and/or energy transmission processes between several pairs of the components 102, 106, 108, 110, 111 and 156 can also be processed at least partially simultaneously. The configuration of the contact-based communication between the components 102, 106, 108, 110, 111 and 156 of the handheld device 100 by means of an universal bus connection 150 on an equal footing permits flexible communication between pairs of components 102, 106, 108, 110, 111 and 156 communicating with one another and ensures rapid transmission of data packets and/or control signals and/or rapid energy transfer.

According to a specific embodiment, in a very specific scenario, the otherwise still maintained principle of the universal bus connection 150 on an equal footing can be modified in such a way that in the event of a collision and/or bandwidth shortage, communication between the machining and driving device 102 on the one hand and the power supply device 110 on the other hand is prioritized. If the data transmission capacity available with the universal bus connection 150 is not sufficient for a quantity of data and/or electrical energy intended to be transmitted between the components 102, 106, 108, 110, 111 and 156, or if different data and/or energy transmission processes interfere with each other, a data and/or energy transmission process can first take place between the machining and driving device 102 on the one hand and the power supply device 110. This can ensure that even in critical operating states, a basic function of the handheld device 100—namely execution of a processing task and provision of the electrical energy required for this-remains ensured.

As previously discussed, in addition to its communication capability via the universal bus connection 150 with the other components 102, 106, 108, 110, 111 of the handheld device 100, the token 156 may communicate with the communication partner device 158 via another wireless communication link 160. To provide this communication capability, the token 156 may be equipped with an additional communication unit 190 (for example, a processor with memory resources). Said communication link 160 may be, for example, a Bluetooth communication link or a Narrowband Internet of Things (NB IoT) communication link. Data can be transmitted unidirectionally or bidirectionally between the handheld device 100 and the communication partner device 158 via the communication link 160. This data can be, for example, a data sheet or a control data set that the handheld device 100 downloads from the Internet. Furthermore, this data may be, for example, documentation data for documenting a processing task performed by the handheld device 100, which is uploaded from the handheld device 100 to the communication partner device 158 for documentation purposes, for example. Since the token 156 handles the communication with the communication partner device 158 via the wireless communication link 160, it is advantageously unnecessary to equip the components 102, 106, 108, 110, 111 of the handheld device 100 with a corresponding wireless communication capability, but without having to dispense with the wireless communication with the communication partner device 158. In that a token 156 can be equipped with a personalized authorization profile, an authorization control for communication over the communication link 160 can also be implemented by inserting a token 156 into a corresponding component 102, 106, 108, 110, 111.

In a preferred embodiment, communication is realized by means of UART at all positions shown in the figures with reference sign 150. Alternatively, for example, communication can be realized between a handheld device 100 and a battery (or another power supply device 110) by means of UART and communication can be realized between a module and a battery (or another power supply device 110) by means of an I²C (Inter-Integrated Circuit) data bus.

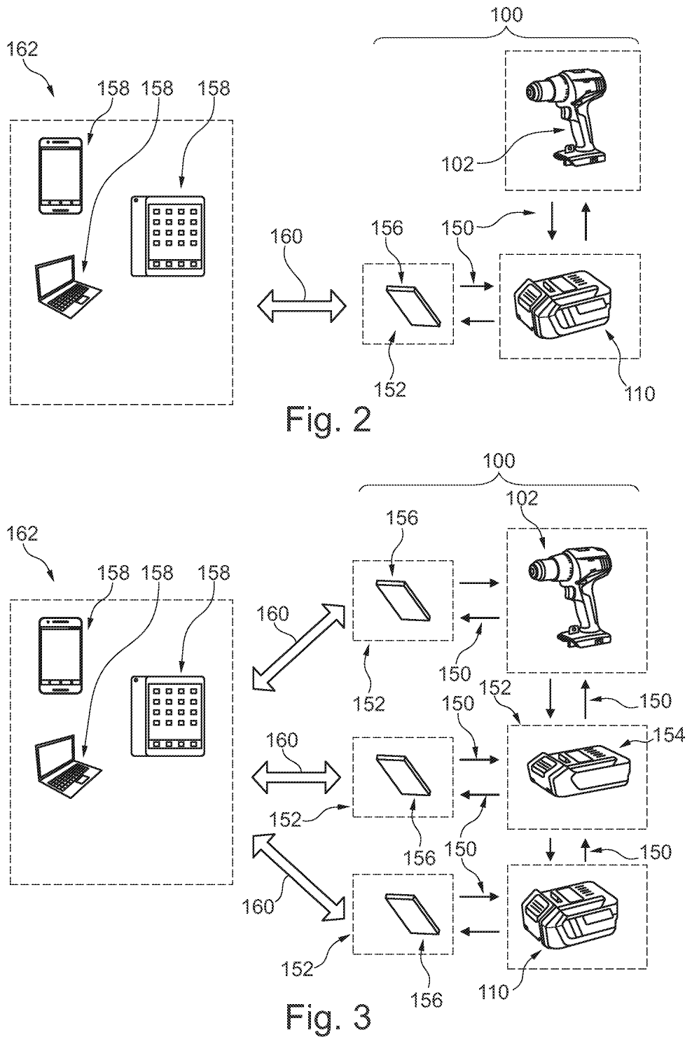

FIG. 2 shows an arrangement 162 with a multi-component handheld device 100 (here formed as a battery-powered handheld machine) and a communication partner device 158 communicably coupled thereto, according to another exemplary embodiment of the invention.

In the architecture according to FIG. 2, the machining and driving device 102 is configured for bidirectional communication with the power supply device 110 by means of the universal bus connection 150. Furthermore, the power supply device 110 (configured as a battery) is configured for bidirectional communication with a further component 152 configured as an IoT token 156 by means of the universal bus connection 150. The token 156 is also used to communicate with a communication partner device 158 by means of a wireless communication link 160 that is different from the universal bus connection 150.

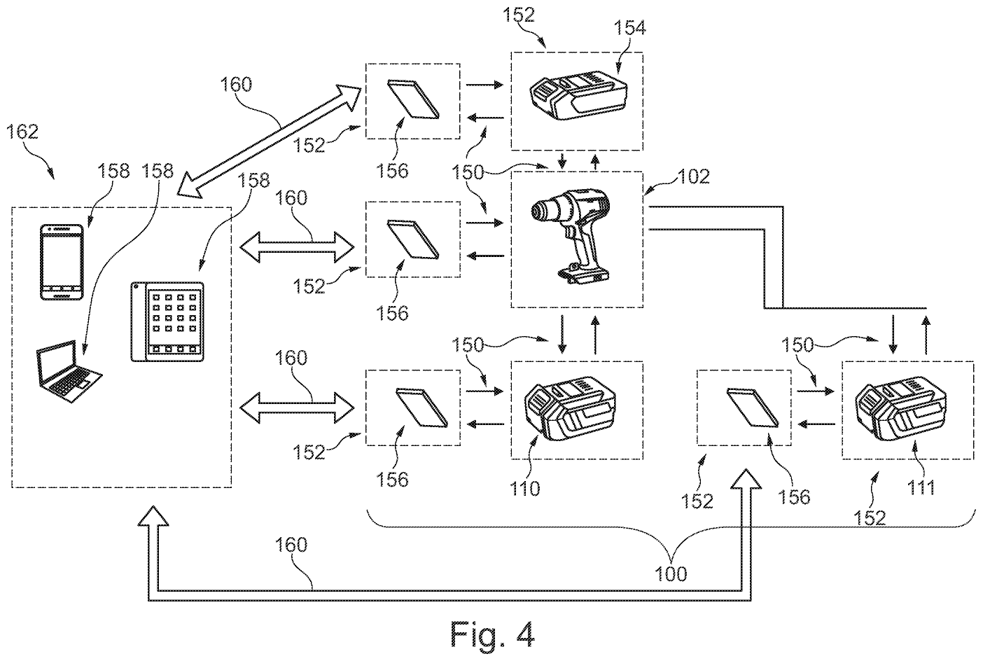

FIG. 2 shows an example of a modular architecture of a handheld device 100 with bus connection as a universal part. The IoT token 156 can be plugged into the power supply device 110, which is configured as a rechargeable battery, A bidirectional (i.e. transmit and receive) UART communication with peer-to-peer functionality is formed between the components 102, 110, 156 of the handheld device 100 by means of the universal bus connection 150 to represent a multi-client architecture. The communication in the transmit and receive direction between the components 102, 110, 156 is shown in FIG. 2 with two antiparallel arrows in each case. Bluetooth communication is enabled between the token 156 and several communication partner devices 158 (in the illustrated embodiment a computer, a tablet and a smartphone) via the communication link 160 (see double arrow). Corresponding antiparallel arrows and double arrows are also shown in FIG. 3 and FIG. 4.

Thus, according to FIG. 2, a uniform communication interface is formed in the form of the universal bus connection 150 between the machining and driving device 102 (i.e., a functional block of the battery-powered handheld machine), the power supply device 110, and the IoT token 156. The machining and driving device 102 communicates with the power supply device 110 (sending and receiving), the power supply device 110 communicates with the IoT token 156, and the IoT token 156 communicates via radio (for example Bluetooth) with communication partner devices 158 (in particular end devices such as computers, tablets, smartphones and other smart devices).

According to an embodiment, the communication between the components via UART, which in principle has equal rights, is not completely equal in an exceptional case. Communication between the power supply device 110 and the machining and driving device 102 preferably has priority. Other processes, such as downloading data sheets from the Internet via the token 156, run in the background.

FIG. 3 shows an arrangement 162 comprising a multi-component handheld device 100 and a communication partner device 158 communicably coupled thereto, according to still another exemplary embodiment of the invention.

According to FIG. 3, the machining and driving device 102 is configured for bidirectional communication with a further component 152 configured as a detection and/or control adapter 154 by means of the universal bus connection 150. Such a detection and/or control adapter 154 is described in more detail in FIG. 5. Furthermore, the detection and/or control adapter 154 is configured for bidirectional communication with the power supply device 110 by means of the universal bus connection 150. In addition, the machining and driving device 102, the detection and/or control adapter 154 and the power supply device 110 are configured for bidirectional communication with a respectively assigned token 156 by means of the universal bus connection 150. In addition, each of the tokens 156 is configured to communicate with a communication partner device 158 in accordance with a wireless communication link 160 that is different from the universal bus connection 150.

In contrast to the embodiment according to FIG. 2, according to FIG. 3, the detection and/or control adapter 154 (illustrated as an adapter between the battery and the machine) is additionally provided, which provides the functionality of a detection unit 106 described herein and/or a control unit 108 described herein. Furthermore, according to FIG. 3, in contrast to FIG. 2, two additional tokens 158 are provided, one of which can be plugged into the machining and driving device 102 and the other into the detection and/or control adapter 154.

Thus, according to FIG. 3, the universal bus connection 150 provides a standardized communication interface between the hand-held machine, adapter, battery and token, which enables data transmission in the send and receive direction (see the two antiparallel arrows).

FIG. 4 shows an arrangement 162 comprising a multi-component handheld device 100 and a communication partner device 158 communicably coupled thereto, according to another exemplary embodiment of the invention.

According to the architecture of FIG. 4, the machining and driving device 102 is configured for bidirectional communication with a further component 152 configured as a detection and/or control adapter 154 by means of the universal bus connection 150. In addition, the machining and driving device 102 is configured for bidirectional communication with the power supply device 110 by means of the universal bus connection 150. Furthermore, the machining and driving device 102 is configured for bidirectional communication with a further component 152 configured as a further power supply device 111 by means of the universal bus connection 150. The detection and/or control adapter 154 is configured to communicate bidirectionally with the power supply device 110 and with the further power supply device 111 by means of the universal bus connection 150 by means of the machining and driving device 102. The machining and driving device 102, the detection and/or control adapter 154, the power supply device 110 and the further power supply device 111 are each configured for bidirectional communication with a respective further component 152 configured as a token 156 by means of the universal bus connection 150. In addition, each of these tokens 156 is configured to communicate with a communication partner device 158 in accordance with a wireless communication link 160 that is different from the universal bus connection 150.

FIG. 4 therefore shows two rechargeable batteries. The universal bus connection 150 enables a standardized communication interface between a hand-held machine, an adapter, two batteries and several IoT tokens. The hand-held machine communicates with the adapter and with the two batteries. Sequential and/or parallel communication is possible. The adapter communicates with the two batteries via the hand-held machine. The hand-held machine also communicates with an IoT token. The adapter also communicates with an IoT token. Each of the batteries also communicates with an IoT token. One or more of the IoT tokens communicates via radio (e.g. Bluetooth) with end devices (computers, tablets, smartphones and other smart devices).

FIG. 5 shows a handheld device 100 according to an exemplary embodiment of the invention. According to FIG. 5, the detection unit 106 and the control unit 108 are configured as an adapter 154 that is physically connected to each other and can be handled separately from the rest of the handheld device 100, which comprises a connecting body 116 mechanically connecting the detection unit 106 and the control unit 108 outside the rest of the handheld device 100.

FIG. 5 shows a handheld device 100 configured, for example, as a cordless impact wrench according to an exemplary embodiment of the invention. With an impact wrench, the screwing in and unscrewing of fastening elements 112 (for example screws) can be carried out by pulse-like rotary movements. According to FIG. 5, a fastening element 112 formed as a screw is to be placed in a pilot hole 140 (or alternatively without a pilot hole) of a substrate 104 formed as a masonry wall, for example, by means of the battery-powered impact screwdriver shown. In order to simplify and improve this substrate machining task, the handheld device 100 can be specially configured, as will be described in more detail below.

The illustrated handheld device 100 is used for manual operation by a user. For this purpose, the user can manually hold the handheld device 100 by a handle 142 and press an actuation button 144 on the handle 142 to activate it. A device housing 146 of the handheld device 100 defines a main body of the handheld device 100, which encloses or houses functional components (for example, an electric drive motor) of the machining and driving device 102 of the handheld device 100. In particular, the machining and driving device 102 has a chuck at a substrate-side end for machining the substrate 104, into which a suitable tool element for screwing the fastening element 112 into the substrate 104 can be inserted in accordance with a substrate machining task to be performed. Such a tool element can, for example, be a bit with an output (in particular a cross-slotted bit) for engaging in a drive (in particular a cross-slotted bit) in a head of the fastening element 112. Such a tool element attached to the machining and driving device 102 can be set into rotation by means of the machining and driving device 102, which can be transmitted to the fastening element 112, which can thereby be set into the substrate 104. In this way, a force transmission in the form of torque and/or impacts can be transmitted from the handheld device 100 to the fastening element 112 by means of the machining and driving device 102, whereby the fastening element 112 is inserted into the substrate 104 and fixed there.

A power supply device 110 configured as a removable and rechargeable battery module in the embodiment shown serves to provide electrical drive energy for driving the machining and driving device 102. For recharging after emptying, the power supply device 110 configured as a battery module can be temporarily removed from the handle 142 on the main body and recharged, for example by means of a charging unit connected to a power supply system.

If a suitable tool element (in particular a suitable bit) is clamped in the machining and driving device 102, the output of the tool element engages the drive of the fastening element 112. If the user then actuates the actuating button 144, electrical drive energy is transmitted from the power supply device 110 to the drive motor of the machining and driving device 102, whereby the fastening element 112 is placed in the pilot hole 140 in the substrate 104.

For example, for retrofitting or for user-defined adaptation of the modular handheld device 100, a detection unit 106 can be attached to the machining and driving device 102. This detection unit 106 is configured for detecting detection data indicative of a force transmission during machining the substrate 104 by means of the machining and driving device 102. More precisely, the detection unit 106 has one or more sensors, for example a torque sensor for detecting a transmitted torque, a longitudinal force sensor for detecting a transmitted longitudinal force or impact force, etc. By detecting a transmitted torque and/or a transmitted longitudinal force or impact force, the force transmission from the handheld device 100 to the fastening element 112 and the substrate 104 can be detected by sensors.

Furthermore, for example, a control unit 108 can be inserted between the main body bounded by the device housing 146 and the removable power supply device 110. The control unit 108 can be communicably coupled to the detection unit 106, for example via an electrical connection line 118 in a connecting body 116 of the adapter 154, for example formed as struts. As shown in FIG. 5, the detection unit 106 and the control unit 108 are mechanically and communicably connected by the connecting body 116 outside the rest of the handheld device 100. Advantageously, the connecting body 116 can also form a mechanical connection between the detection unit 106 and the control unit 108 in addition to a communication link. By means of the communication device 119, detection data detected by the detection unit 106, which characterize the transmission of force during processing of the substrate 104, can be transmitted to the control unit 108. The control unit 108 can have a processor that can process the detection data in order to control or regulate the machining of the substrate 104 based on the detection data. In particular, the control unit 108 can compare the detection data characterizing the actual machining of the substrate 104 with a target specification. The target specification can specify the way in which the substrate 104 should ideally be machined using the handheld device 100. If the control unit 108 detects discrepancies between the actual machining and the target specification, the control unit 108 can adapt the control of the functional components of the handheld device 100 (in particular the machining and driving device 102) in order to ensure that the target specification is adhered to or at least better approximated during the further machining of the substrate 104. For this purpose, one or more operating parameters of the handheld device 100 can be set, changed or tracked. For example, the transmitted torque, a number and/or an intensity of strokes exerted, etc. can be set accordingly by the control unit 108. In particular, the control unit 108 can, for this purpose, control the power supply device 110 in a suitable manner to provide electrical energy to the drive motor in the device housing 146 or limit the electrical energy accordingly in order to fulfill the target specification. For this purpose, the control unit 108 is advantageously adapted at its opposite ends to the geometry of the power supply device 110 or the device housing 146, so that the control unit 108 can be mounted positively between the machining and driving device 102 and the power supply device 110 and can intervene in a controlling manner directly between the described components of the handheld device 100.

Advantageously, the handheld device 100 is configured to be selectively operable with or without the detection unit 106 and/or with or without the control unit 108, so that the handheld device 100 is also operable without the detection unit 106 and/or control unit 108.

Advantageously, the detection unit 106 can be configured to detect the detection data indicative of a force transmission during machining of the substrate 104 by means of the machining and driving device 102 at the start of a machining task. Thus, when the user begins to rotate the fastening element 112 engaged with the tool element on the machining and driving device 102 by actuating the actuating knob 144 and thereby placing it in the pilot hole 140 in the substrate 104, the detection of torque and/or longitudinal force can begin. Corresponding detection data is transmitted from the detection unit 106 to the control unit 108 via the connection line 118. In the embodiment shown, the control unit 108 is configured to adapt the further machining of the substrate 104 based on the detection data detected at the start of the machining task in such a way that the further execution of the machining task is carried out in accordance with a target specification. If, for example, the control unit 108 determines that the actually transmitted sensor-detected torque is too large or too small compared to a target torque defined in the target specification, the control unit 108 can influence the power supply device 110 and thus also the drive motor in the device housing 146 in such a way that an actual torque of a suitable size corresponding to the target torque is subsequently exerted on the fastening element 112 by the machining and driving device 102.

FIG. 5 also shows that a receiving opening 159 for inserting a token 156 not shown in FIG. 5 can be provided on the handheld device 100 (for example on the device housing 146). The token 156 can have a functionality as described in FIGS. 1 to 4 or FIG. 6.

FIG. 6 shows an arrangement 162 comprising a handheld device 100 and a token 156 coupled to one or more communication partner devices 158 in a communication network 180 according to an exemplary embodiment of the invention.

The token 156 has a processor 166, which can be configured for control-related interaction with a machining and driving device 102 and a power supply device 110 (and optionally at least one further component 152, for example a detection unit 106 and/or a control unit 108, not shown in FIG. 6) of the handheld device 100. Furthermore, the token 156 has an electromechanical coupling device 170, which is configured for electromechanical coupling with the machining and driving device 102 (comprising, among other things, a drive motor 199) and the power supply device 110 (and optionally with at least one further component 152). This mechanical coupling can be accomplished, for example, by means of a receiving opening 159 of the respective component 102, 110, 152. In addition, the token 156 can be configured to control the respective one of the machining and driving device 102 or the power supply device 110 (or optionally the at least one further component 152) by means of the processor 166 when the electromechanical coupling device 170 is mechanically coupled to a respective one of the machining and driving device 102 or the power supply device 110 (or the optional at least one further component 152).

When an electromechanical connection is formed between the token 156 and the handheld device 100 by inserting the electromechanical coupling device 170 of the token 156 into the receiving opening 159 of the handheld device 100, a communication link is simultaneously formed between the token 156 and other components of the handheld device 100. More specifically, in the illustrated embodiment, an electrical connection is formed between one or more electrical contact elements 182 on an outer side of the token 156 and one or more electrical contact elements 184 on an inner side of the receiving opening 159 of the handheld device 100. The formation of a form fit between the token 156 and the receiving opening 159 in the handheld device 100 thus leads to the formation of an electrical contact and thus an electrically conductive connection between the token 156 and the other components of the handheld device 100. This electrical connection also forms an electrical communication link between the token 156 and the other components of the handheld device 100, which in particular enables the transmission of electrical signals (for example control signals) and/or electrical energy.

Advantageously, when a token 156 has been brought into communication with the other components of the handheld device 100 by inserting it into the receiving opening 159 of the handheld device 100, it can be configured to control this handheld device 100 or a component 102, 110, 152. Operation of the handheld device 100 in a state without coupling with the token 156 can be prevented. In other words, only successful pairing of the token 156 in the handheld device 100 can enable its use.

The handheld device 100 may include a control device 138, which may be configured to control the handheld device 100 (for example, when a handheld device 100 is not paired with a token 156) and/or to interact with a processor 166 of a paired token 156.

Advantageously, the handheld device 100 for pairing with the tokens 156 may be configured such that a use of a handheld device 100 paired with a token 156 by a user may be allowed, set and/or prevented based on a personalized authorization profile. More specifically, a user of a token 156 may be assigned a user profile that may include information with respect to an enablement and authorization of that user to use certain handheld devices 100, but may also define usage restrictions and/or usage prohibitions with respect to certain handheld devices 100. Such a user profile may be stored in a memory device 128 of a token 156, in a memory device 141 of the handheld device 100 and/or in a database 132 of a communication partner device 158 (in the illustrated embodiment, a central control device) communicably coupled to the token 156 via the communication network 180.

The structure of the token 156, which is shown in detail in FIG. 6, is described in more detail below as an example. Said token 156 is used, for example, for user-related control of a selectable handheld device 100 and has the processor 166 for this purpose. For example, the processor 166 may be embedded inside the token 156 and thereby protected. The processor 166 may, for example, be configured as a microprocessor. It is possible to form the processor 166 as a part of a processor unit, as an entire processor unit or as a plurality of cooperating processor units. The processor 166 of the token 156 is used for control interaction with the handheld device 100 or one of its components 102, 110, 152.

Further, the token 156 includes a cryptographic unit 168 that supports cryptographic communication of the token 156. More specifically, the cryptographic unit 168 can be used to encrypt a communication of the token 156 with a communication partner device 158 in the communication network 180. For example, such encrypted communication supported by the cryptographic unit 168 can take place between the token 156 on the one hand and a central control device, a user terminal and/or a reordering device as communication partner device 158 on the other hand. Encrypted communication increases data security during communication via the communication network 180. Optionally, it is also possible to use the cryptographic unit 168 to carry out encrypted communication between the token 156 and the handheld device 100 mechanically coupled to it, for example when transmitting control signals from the token 156 to the handheld device 100.

As already mentioned, the token 156 has the electromechanical coupling device 170, which is configured for preferably positive mechanical coupling with the receiving opening 159 of the handheld device 100 or one of its components 102, 110, 152. The electromechanical coupling device 170 of the token 156 is defined by its outer shape, which is shaped inversely to the inner shape of the receiving opening 159.

Advantageously, the token 156 may be configured to control the operation of said handheld device 100 by means of the processor 166 (and optionally the cryptographic unit 168 using cryptographic communication) when the electromechanical coupling device 170 is mechanically coupled to a receiving opening 159 of the handheld device 100. More specifically, the processor 166 of the token 156 may control the handheld device 100 to perform the desired processing task as intended. For example, the processor 166 of the token 156 may specify the torque to be applied by a drill bit of a handheld device 100 configured as a drill to a substrate 104 in which a borehole is to be drilled.

Advantageously, the token 156 can be configured for user-related control of the handheld device 100, in particular on the basis of a personalized authorization profile of the user. For this purpose, the token 156 can be provided with an identification device 172, which is configured to identify a user of the token 156. The identification device 172 is formed by a sensor 174, configured for example as a fingerprint sensor, and the part of the processor 166 that identifies the user from sensor data determined by means of the sensor 174, for example by pattern matching with reference data. More precisely, the sensor 174 is configured, for example, as a fingerprint sensor on which a user places a finger for identification. Advantageously, the sensor 174 can therefore be located in a surface area of the token 156. The sensor 174 can then determine whether the data captured by the sensor 174 indicates that the user is an authorized or rightful user or which user the user is. This determination can be made by comparing the sensor-acquired data with sensor reference data (for example, a fingerprint of an authorized user stored in a database).

The processor 166 may be configured to control the operation of the handheld device 100 coupled to the token 156 in accordance with the user authorization profile of the user of the token 156. In particular, the processor 166 may be configured to enable operation of the handheld device coupled to the token 156 only if a user identification performed in advance using the token 156 has resulted in an identifying user being authorized to operate the handheld device 100. Advantageously, the processor 106 of the token 156 can thus be configured to permit, set and/or prevent use of the handheld device 100 by the user based on the personalized authorization profile when it is paired with the handheld device 100.

The token 156 may, for example, be configured as a plug-in element for insertion into the receiving opening 159. For example, each token 156 may be formed as a circular disk with a diameter in a range of 2 cm to 4 cm and is therefore conveniently manageable by a user and can be inserted into a handheld device 100 in a space-saving manner. Furthermore, the electromechanical coupling device 170 of the token 156 is configured to detachably couple the token 156 to the handheld device 100. Thus, a user can use a token 156 (assigned to him, for example) successively in combination with different handheld devices 100, whereby the selection of an addressed handheld device 100 can be made by merely mechanically inserting the electromechanical coupling device 170 of the token 156 into an associated receiving opening 159 of a target handheld device 100 or a target component 102, 110, 152.

As previously mentioned, the token 156 may include one or more sensors 174, including the user identification sensor described above. It is alternatively or additionally possible to equip the token 156 with, for example, a gyro sensor, a location sensor and/or a temperature sensor. A gyro sensor can detect, for example, when a handheld device 100 with a token 156 held in it falls down and is consequently subjected to a shock. In this case, the handheld device 100 can be switched off as a precaution in order to prevent injury to a user and damage. A location sensor (for example a GPS sensor) of the token 156 allows the current position of the token 156 together with the handheld device 100 to be detected. The use of a handheld device 100 can be restricted (for example in a user profile) to a specific spatial area (for example a specific construction site), for example to prevent misuse. If a location sensor detects that a handheld device 100 including token 156 is located in a location not authorized for use, the processor 166 of the token 156 can switch off or deactivate the handheld device 100 to prevent misuse. A temperature sensor of the token 156 can detect the ambient temperature. If a processing task (for example, setting a chemical dowel) is only permitted under certain temperature conditions, operation of the handheld device 100 can be made impossible for safety reasons if a temperature condition is not met in view of detected temperature sensor data.

Optionally, the token 156 has a power supply device 176, for example a replaceable battery or a rechargeable battery. The token 156 can then be operated autonomously. Alternatively or additionally, the token 156 can be supplied with electrical energy by the power supply device 110 of the handheld device 100 when the token 156 is received in the receiving opening 159.

FIG. 6 further shows that the token 156 can have a communication antenna 178, for example a WLAN antenna. It is also possible and advantageous for reasons of diversity if the token 156 has several communication antennas 178 which, for example, support different communication protocols. For example, a communication antenna 178 may be realized in the form of a planar coil, which is preferably arranged in a surface area of the token 156.

The token 156 shown in FIG. 6 has a communication device 119, which may be formed by interaction of the communication antenna 178 with a corresponding part of the processor 166 and optionally with the cryptographic unit 168. The communication device 119 is used for communicating the token 156 with one or more communication partner devices 158 via the communication network 180, which may be, for example, the public Internet, an intranet or a mobile network.

For example, it is possible to form a communicable coupling between the token 156 and an app or other software stored on a portable user terminal of the communication partner devices 158 via the communication network 180. In the illustrated embodiment, the user terminal device is a mobile communication device with a user interface with which a user can control and/or monitor the communicably coupled token 156 and/or a handheld device 100 coupled thereto. By means of the user terminal, a user can also control and/or monitor the handheld device 100 from a remote position. For example, a token 156 can connect to the user terminal device, which is configured here as a mobile communication device, via an app. The user terminal device can be used to download data to the token 156, for example a user profile of a user of the user terminal device. Furthermore, it is possible for the token 156 to access resources of the user terminal device during operation, for example a processor contained therein and/or a camera of the user terminal device.

Alternatively or additionally, it is possible to form a communicable coupling between the token 156 and a central control device as a communication partner device 158 via the communication network 180. The central control device can be equipped with an access right to a database 132, from which data records can be transmitted to the token 156. Such data records may include, for example, a user profile requested by the token 156, an operational data record for performing a processing task with a handheld device 100 mechanically coupled to the token 156, etc. Thus, the token 156 can be configured to download a data record by means of the communication device 119 from the central control device or another node of the communication network 180 that is coupled with communication capability, in particular a data record defining an operating sequence of the handheld device 100 and/or a data record defining a user profile of a user of the token 156.

Furthermore, the communicable coupling between the token 156 and the central control device makes it possible to transmit data from the token 156 to the control device for storage in the database 132. Such data may be, for example, tracking data that allows tracking of a handheld device 100 coupled to a respective token 156. Thus, the token 156 can be configured to upload a data set by means of the communication device 119 to the control device or another communication partner device 158 coupled in a communicable manner, in particular a data set containing operating results and/or operating parameters of an operation of the handheld device 100.

In addition, it should be noted that “comprising” does not exclude other elements or steps and “one” or “a” does not exclude a plurality. Furthermore, it should be noted that features or steps described with reference to one of the above embodiments may also be used in combination with other features or steps of other embodiments described above. Reference signs in the claims are not to be regarded as a limitation.

1. A handheld device for manual operation by a user, the handheld device comprising:
a machining and driving device which is configured for machining a substrate by means of a driving force; and
at least one further component which can be electromechanically coupled or is coupled to the machining and driving device;
wherein the machining and driving device and the at least one further component are configured to communicate with one another on an equal footing by means of a universal bus connection.

2. The handheld device according to claim 1, comprising a power supply device, for example at least one battery pack, which is configured to provide drive energy for driving the machining and driving device;
wherein the at least one further component is electromechanically couplable or coupled to the power supply device; and
wherein the machining and driving device, the power supply device and the at least one further component are configured to communicate with one another on an equal footing by means of the universal bus connection.

3. The handheld device according to claim 1, comprising at least one of the following features:
wherein the universal bus connection is a Universal Asynchronous Receiver Transmitter bus connection;
wherein the universal bus connection provides peer-to-peer communication between the machining and driving device, the power supply device and the at least one further component;
wherein the machining and driving device, the power supply device and the at least one further component are configured to communicate with one another on an equal footing by means of the universal bus connection with the proviso that communication between the machining and driving device and the power supply device is prioritized in the event of a collision and/or in the event of a bandwidth shortage;
wherein the machining and driving device, the power supply device and the at least one further component are configured to communicate with each other simultaneously or sequentially by means of the universal bus connection.

4. The handheld device according to claim 1, wherein the at least one further component comprises:
a detection unit which is configured to detect detection data indicative of force transmission during machining of the substrate by means of the machining and driving device; and/or
a control unit which is set up to control the processing of the substrate in accordance with a target specification, in particular based on detection data detected by means of a detection unit.

5. The handheld device according to claim 4, comprising at least one of the following features:
wherein the detection unit can be attached or is attached to the machining and driving device, in particular is configured as a removable detection adapter;
wherein the control unit can be attached or is attached to the power supply device, in particular is configured as a removable control adapter;
wherein the detection unit and the control unit form an adapter which is physically connected to one another and can be handled separately from the rest of the handheld device, in particular comprising a connecting body mechanically connecting the detection unit and the control unit outside the rest of the handheld device.

6. The handheld device according to claim 1, wherein the at least one further component comprises at least one token formed in such a way that the token controls at least a part of the handheld device when mechanically coupled to at least one of the machining and driving device, the power supply device and another of the at least one further component, and/or transmits data, in particular parameter values, between components (102, 110, 152), in particular the token being configured as a plug-in element for insertion into a receiving opening, in particular configured as an electromechanical interface, of at least one of the machining and driving device, the power supply device and the other of the at least one further component.

7. The handheld device according to claim 6, wherein the token comprises:
a processor configured to control interaction with the machining and driving device, the power supply device and optionally the other of the at least one further component; and
a mechanical coupling device which is configured for mechanical coupling with the machining and driving device, the power supply device and optionally the other of the at least one further component;
wherein when the mechanical coupling device is mechanically coupled to a respective one of the machining and driving device, the power supply device and optionally the other of the at least one further component, the token is configured to control the respective one of the machining and driving device, the power supply device or the optional other of the at least one further component by means of the processor.

8. The handheld device according to claim 6, wherein the token is configured to communicate with a communication partner device by means of a communication link that is different from the universal bus connection, in particular a wireless communication link.

9. The handheld device according to claim 2, wherein:
the machining and driving device is configured for bidirectional communication with the power supply device by means of the universal bus connection;
the power supply device is configured for bidirectional communication with a further component configured as a token by means of the universal bus connection; and
the token is configured to communicate with a communication partner device by means of a wireless communication link different from the universal bus connection.

10. The handheld device according to claim 2, wherein:
the machining and driving device is configured for bidirectional communication with a further component configured as a detection and/or control adapter by means of the universal bus connection;
the detection and/or control adapter is configured for bidirectional communication with the power supply device by means of the universal bus connection;
each of the machining and driving device, the detection and/or control adapter and the power supply device is configured for bidirectionally communication with a respective token of the at least one further component by means of the universal bus connection; and
each of the tokens is configured to communicate with a communication partner device by means of a wireless communication link different from the universal bus connection.

11. The handheld device according to claim 2, wherein:
the machining and driving device is configured for bidirectional communication with a further component configured as a detection and/or control adapter by means of the universal bus connection;
the machining and driving device is configured for bidirectional communication with the power supply device by means of the universal bus connection;
the machining and driving device is configured for bidirectional communication with a further component configured as a further power supply device by means of the universal bus connection;
the detection and/or control adapter is configured for bidirectional communication with the power supply device and with the further power supply device by means of the universal bus connection by means of the machining and driving device;
each of the machining and driving device, the detection and/or control adapter, the power supply device and the further power supply device is configured for bidirectional communication with a respective further component configured as a token by means of the universal bus connection; and
each of the tokens is configured to communicate with a communication partner device by means of a wireless communication link different from the universal bus connection.

12. The handheld device according to claim 1, configured as at least one of a group consisting of a drill, a cordless screwdriver, a cordless drill driver, a rotary screwdriver, a pulse screwdriver, a ratchet screwdriver, an impact wrench, in particular a cordless impact wrench, a hammer drill, and an eccentric grinder.

13. An arrangement, comprising:
a handheld device according to claim 1; and
at least one communication partner device which is configured to communicate with at least one of the machining and driving device and the at least one further component by means of a communication link which is different from the universal bus connection.

14. The arrangement according to claim 13, comprising at least one of the following features:
wherein the at least one communication partner device is adapted to communicate with a power supply device configured to provide drive power for driving the machining and driving device by means of the communication link different from the universal bus connection;
wherein the at least one communication partner device is selected from a group consisting of a computer, in particular a central control computer or a reordering device, and a portable user terminal, in particular a tablet or a mobile communication device;
wherein the at least one communication partner device and the handheld device are coupled or can be coupled in a communicative manner by means of a communication network, in particular the Internet, an intranet or a mobile communication network;
wherein the communication link different from the universal bus connection is a wireless communication link;
wherein the communication link is a Bluetooth communication link, a GPS communication link, a BLE communication link, an ultra-wideband communication link, a WLAN communication link, a Narrowband Internet of Things communication link, a 5G communication link, an LTE communication link, a COTM communication link, a SigFox communication link and/or a LoRa communication link.

15. A method of controlling a handheld device configured for manual operation by a user, in particular according to claim 1, the method comprising:
machining of a substrate using a driving force by means of a machining and driving device;
providing drive energy for driving the machining and driving device;
electromechanical coupling of at least one further component to the machining and driving device; and
communication on an equal footing between the machining and driving device and the at least one further component by means of a universal bus connection.
